(19) United States
(12) Patent Application Publication
(10) Pub. No.: US 2005/0058579 A1
(43) Pub. Date: Mar. 17, 2005

(54) Acoustic energy transducer

(76) Inventor: Amos E. Cline, Greenfield Township, ME (US)

Correspondence Address: BOHAN, MATHERS & ASSOCIATES, LLC, PO BOX 17707, PORTLAND, ME, 04112-8707, US

(21) Appl. No.: 10/663,106

(22) Filed: Sep. 16, 2003

(51) Int. Cl. B06B 1/00

(52) U.S. Cl. 422/127; 422/128

(57) ABSTRACT

A transducer for converting flow energy to acoustic energy, requiring little or no electrical excitation of the device. Process liquid flows through an orifice into the device, past oscillatory members made of resilient material in a high-Q configuration prone to vibration. The turbulent flow of the process liquid causes the oscillatory members to vibrate and, eventually, to resonate. Acoustic waves propagate from one oscillatory member to another oscillatory member and back, conserving acoustical energy and exerting extreme compression and shear forces on the process liquid. Rarefaction may result in cavitation, resulting in extreme local and instantaneous pressures and temperatures. The device is suitable for applying physical work to process fluid for the purpose of destroying bacteria, homogenization, or promoting sonochemical reactions between fluids.

### BACKGROUND INFORMATION

1. Field of the Invention

The invention relates to the field of acoustic energy. More particularly, the invention relates to a device that converts flow energy to acoustic energy. More particularly yet, the invention relates to an acoustic energy device for application in sonochemical processes and food-sanitizing processes.

2. Description of the Prior Art

Ultrasonic devices are widely used to clean and sterilize medical instruments, as well as surfaces in general, and are also used for promoting sonochemical processes. Such devices typically use an electronic transducer or sound generator, usually a piezo crystal. Sometimes a horn is used to couple and transfer acoustic waves into a fluid. The acoustic waves create cycles of compression and rarefaction forces propagating though the fluid.

Cavitation is one well-known effect of acoustic waves acting on a fluid. At ultrasound levels (20 kHz or higher), the rarefaction cycle of an acoustic wave may exceed the attractive forces of the molecules of the liquid through which the wave is traveling. As a consequence, molecules pull apart, causing cavitation bubbles to form. A bubble typically forms about a perturbation point and expands to a size that is determined by absolute pressure, acoustic wave amplitude, frequency of the wave and fluid composition. Following the rarefaction cycle, the bubble collapses as the gas condenses to a liquid. This creates a very high vacuum condition that accelerates the bubble toward its center point. The subsequent compression cycle causes a high pressure that adds to the force causing the bubble collapse. As the bubble collapses, the liquid forming the bubble accelerates to near supersonic velocities. The momentum of the collapsing bubble is dissipated in the minute point that was the center of the bubble. Due to the rapid cycles of heating-cooling and pressurization-depressurization, the flow of acoustic energy through a fluid creates extraordinary physical and chemical conditions. It has been estimated that, in aqueous systems at an ultrasonic frequency of 20 kHz, the collapse of a bubble generates temperatures of about 4,000 K and pressures in excess of 1000 atm. These extreme conditions promote reactivity between otherwise non-reactive substances and also create an environment that is hostile to biological organisms by effectively rupturing the cell walls of biological organisms.

During cavitation, particles in solids may produce high-speed jets of liquid. These high-speed jets, together with the associated shock wave, accelerate the solid particles to high velocities. The collision of these jets with other particles or surfaces results in local melting or material removal, which, in turn, results in dramatic changes in surface morphology. Cavitation and the ensuing jets of liquid with particles are responsible, for example, for the pitting on ship propellers or spillways of large dams. It is these jets that are used to clean surfaces of implements. Even at ultrasonic levels that do not result in cavitation, the forces acting on the fluid produced by the acoustic waves traveling through the fluid create conditions of high shear and turbulence that bring about very useful and desirable results.

Many different types of transducers for converting mechanical or thermal energy into acoustic energy are known. A gas-driven transducer, for example, is such a device. Generally, the gas-driven transducer has an orifice through which gas flows and rapidly expands, creating a shock wave which travels across a resonator gap and on into a resonator chamber. The sound waves are reflected from the walls of the resonator chamber and eventually forced back through the resonator gap, where they are focused and create an intense field of acoustic energy. Process liquid also flows through this resonator gap. The extreme shear forces resulting from the intense and rapidly forming compression cycles of the sound waves shear the droplets into very fine droplets. The primary object of such a process is not to generate cavitation, but rather, to use the shear forces generated by the compression cycles of the shock waves. Such a transducer is shown in T. J. Mason, Introduction to Sonochemistry 3. This device uses a fluid (a gas) to produce the acoustic waves, which are then applied to the process liquid. Thus, the device requires that two fluids flow through the device. This use of a second fluid to produce the acoustic energy that works on the first fluid is inefficient and uneconomical, as it requires a flow control of the fluids and a device that provides separate channels for the introduction of the fluids into the device.

A liquid-driven transducer, also referred to as a “liquid whistle,” is used for homogenizing otherwise immiscible liquids. The process liquid is forced through an orifice into a chamber in which a vibrating member, such as a thin blade, is mounted. The liquid rapidly expands after passing through the orifice and the resulting turbulent flow passes over the vibrating member. The rarefaction cycles of the sound waves generated by the vibrating member cause cavitation in the process liquid and the extreme heat and pressures generated during cavitation result in a mixing of the materials. The size and shape of the orifice and the velocity are adapted to the particular application to obtain the necessary particle size and degree of dispersion to achieve efficient homogenization.

It is also know to use a transducer with plates made of magnetostrictive material for generating high power ultrasound and converting the sound energy to mechanical or thermal energy. Magnetostrictive material reduces in size when placed in a magnetic field and returns to normal size when the field is removed and, is caused to vibrate by cyclically applying a magnetic field to it. Such transducers are rugged and stable, but are limited in their ability to be adapted to optimal parameters for a specific application because the frequency at which the magnetostrictive material is capable of responding to changes in magnetic field is limited to 100 kHz.

Piezoelectric transducers do not have the limitation of the magnetostrictive transducers. Material exhibiting the piezoelectric effect gives off a voltaic charge when pressure is applied to it. The piezoelectric properties have a direct effect, in which, when pressure is applied across large surfaces of the material, an electric charge is generated on each face, equal in size, but opposite in polarity, and an inverse effect, in that, when a charge is applied to one face of a section and an equal, but opposite, charge applied to the other face, then the whole section of the material will either expand or contract, depending on the polarity of the respectively applied charge. Since quartz is not a particularly suitable material, being very brittle and difficult to machine, the piezoelectric material is generally provided in the form of ceramic plates. One disadvantage of such devices is that the ceramic material degrades under conditions of high temperature and high pressure and, thus, the device must be cooled if it is to be used for extended periods of time at high temperatures.

The elimination of bacteria in foodstuffs has been a matter of concern ever since the discovery of bacteria. The growth of bacteria in food is a primary source of food spoilage, and is a major health concern, as thousands of persons in the USA alone suffer illness each year as a result of ingesting bacteria-contaminated food. Today, a number of different methods of killing bacteria are applied to food, such as heating food to a temperature high enough to kill bacteria, cooking, freezing, or irradiating food. Liquid foodstuffs, particularly, lend themselves to the process of pasteurization, that is, heating to a certain temperature and then cooling the liquid. The problem with pasteurization is that the heating process often changes the flavor and/or odor of the food. Apple cider is an example of a food that tastes noticeably different and less palatable after it has been pasteurized.

What is needed, therefore, is a device that efficiently converts flow energy to acoustic energy. What is further needed is such a device that generates acoustic energy of sufficient force to rupture cell walls of microbes in liquid foodstuffs. What is yet further needed is such a device that is economical in construction and use, and that can rapidly sanitize large quantities of liquid foodstuffs.

### BRIEF SUMMARY OF THE INVENTION

It is an object of the present invention to provide a device that efficiently converts flow energy to acoustic energy. It is a further object to provide such a device that generates acoustic energy with sufficient force to rupture cell walls of microbes in liquid foodstuffs. It is a yet further object to provide such a device that is a sonochemical device that promotes reactions between typically non-reactive substances.

The objects are achieved by providing a device that forces liquid to flow through a housing past oscillatory members in a turbulent, non-linear path. The device comprises essentially a housing with an inlet and an outlet, and oscillatory members assembled within the housing. Both the housing and the oscillatory members are made of highly resilient materials and are prone to oscillation.

The device according to the present invention is a strictly mechanical device. A differential pressure is applied between the inlet and outlet, forcing a continuous flow of the liquid to be sanitized through the device. In other words, the flow into the device is not pulsed. The flow itself causes the oscillatory members to oscillate and generate acoustic waves. Electrical excitation is not used to generate the acoustic waves and, as a result, there is no loss of energy due to converting electrical energy into acoustic energy.

Baffles, piezo-electric members, or components that are prone to oscillation are used as the oscillatory members. The energy of flow from high pressure to a lower pressure is dissipated in the form of turbulence as the fluid flows through the device. The turbulence applies varying pressure to the oscillatory members, causing them to vibrate and, eventually, to resonate. Baffles or dividing walls are used to configure the flow path of process liquid such that it is redistributed through the device in a non-linear path. This increases the probability that every molecule of the process liquid will be acted upon by the acoustic energy generated by the oscillatory members.

In one configuration of the device according to the invention, one or more sets of baffles are used as the oscillatory members and are assembled between the inlet and outlet. Flow-through apertures are provided in the baffles, such that the flow is forced into a non-linear path that creates turbulence. For example, one set of baffles comprises thin, flat discs with a through-hole through the center of the disc. Interspersed between these baffles is a second set of baffles comprising thin, flat discs, each of which has a number of holes spaced around the perimeter of the disc, rather than a central through-hole. As the process liquid flows through the device, the turbulent flow forces the baffles to deflect with the flow. Eventually, depending on the turbulence, the shape and size of the baffles, and the tendency of the material used for the housing and the baffles to vibrate, the device will begin to oscillate and resonate, producing acoustic waves at the principal resonate frequency and in many harmonic frequencies.

The acoustic waves propagate in all directions through the device, from baffle to housing wall, back toward the center of the housing, generating forces of compression and rarefaction, as well as shear forces, that operate on the process liquid. Indeed, because the housing and the oscillatory members are so prone to oscillation, a fly-wheeling effect takes place, whereby energy moves from flow energy to acoustic energy and back and forth, until the energy is dissipated. Some of the energy is converted to friction, of course, but most of the energy stays within the housing and works on the fluid until it is dissipated, rather than being absorbed by the housing.

Ideally, the baffles are spaced close enough together that adjacent baffles almost touch each other as they deflect with the propagation of a wave. In addition to the compression and shear forces generated during the wave cycles, the moving together of two adjacent baffles increases the pressures exerted on the turbulently flowing process liquid. Depending on several factors, such as the wave attenuation properties of the liquid, the spacing of the baffles in the device, and the resonating frequency of the device, the frequency and amplitude of the acoustic wave are adapted so obtain forces of compression and shear sufficient in strength to rupture the walls of micro-organisms in the process liquid and thus, to produce a sanitized process liquid.

Rarefaction cycles are, of course, also present and generate strong tension forces on the molecules in the liquid, causing cavitation, whereby the molecules tend to pull apart and to form bubbles. In the device according to the present invention, it is not necessary that cavitation occur in order to effectively sanitize the process liquid. For some applications, however, it may be desirable to encourage cavitation. Applying a negative pressure to the outlet end of the device promotes cavitation.

A second configuration of the device according to the invention is constructed with piezoelectric members instead of sets of baffles with flow-through apertures. As with the first configuration, the housing has an inlet and outlet, across which a differential pressure is applied. Also, the housing and the piezoelectric members are made of resilient materials. In a device that uses at least one pair of piezoelectric members, the members are arranged lengthwise within the housing and oscillate in a direction that is transverse to the general direction of flow through the device. The pair is electrically connected to each other and to an oscillating circuit. As the process liquid flows into the housing through the inlet, flow becomes turbulent because of an expansion in the flow area. In addition to the piezoelectric members, depending on the size of the device, one or more baffles or dividing walls may be placed within the housing to divide the flow into smaller flow paths. As described above with the baffles, the turbulent flow causes the piezoelectric members to oscillate, subjecting the process liquid to compression and shear forces arising from the acoustic waves propagating through the process liquid toward the housing wall and back into the flow path. External electrical components may be required to establish an initial imbalance in a piezo-pair to cause it to oscillate at a desired frequency that may also be variable. These components may be active or passive. External components are not intended to be the primary source of energy used to cause the device to oscillate. The external components are to control frequency and amplitude, and to supply make-up energy as needed to maintain a particular set of operating conditions. The piezo-crystals act like capacitors in a high-Q electronic tank circuit, using inductors to induce fly-wheeling and coupled with capacitors to determine frequency. A diode and a pulse generator are used to establish and maintain oscillation, and to supply make-up energy as needed, using conventional electronic techniques.

Ideally, regardless of the configuration of the device, the walls of the housing are made of highly sound-reflective or resilient material, so that the sound energy is not absorbed by the device, but is largely conserved, and, in effect, flywheeled back and forth between flow energy and acoustic energy within the device. The acoustic energy remains in close proximity to the liquid, and consequently, the dissipation of that energy requires that almost all the energy resulting from the flow, be it from shear, turbulence, friction, compression, rarefaction, and cavitation forces, operates directly on the process liquid. The shear forces generated in the resonating device that operate on the process liquid are extreme and are strong enough to destroy the tough outer wall of bacteria or provide the energy and proximity for chemical reactions. Thus, whether or not cavitation occurs, the shear forces alone are generally sufficient to provide the desired sanitization of the process liquid. Depending on the particular application, the parameters of the device are adapted to provide the shear forces required to do accomplish the task at hand.

Ultimately, practically all the acoustic energy is dissipated in heat and causes the temperature of the process liquid to rise. High temperatures are not desirable when sanitizing foodstuffs and it may be necessary and/or desirable to control the temperature of the process liquid by conventional temperature-control methods.

The process of sanitizing the liquid is a continuous process. In order to ensure destruction of microbes in the process liquid, it is critical that all of the liquid flowing through the device have a nearly 100% probability of being subjected to the desired level of acoustic energy with adequate dwell time. High turbulence increases the dwell time of the liquid in the device and also increases the likelihood that the acoustic energy in the device operates directly on all molecules of the process liquid before the liquid exits the device. The turbulence is a function of the rate of expansion in flow area as the process liquid flows into the housing, as well as of the system of baffles or dividing walls arranged within the housing. It is, for example, desirable to increase the dwell time of liquids that attenuate a significant portion of the acoustic energy, such as colloids or gels, by increasing the flow path within the device.

The device according to the invention is also suitable for use in sonochemical processes to force a reaction between reactants that normally do not react with each other. Such reactants are forced to flow through the device and are subjected to the acoustic energy. Cavitation, with its localized releases of extremely high heat and pressures, also promotes chemical reaction between otherwise non-reactive substances. Dwell time of the process liquid in the device is adapted to promote the complete combination of the reactants. As mentioned above, dwell time is easily adjusted by controlling the flow path and/or amplitude of turbulence, extremely high turbulence increases the pressure drop across the device which decreases the flow rate thereby increasing the dwell time in the device.

To increase the efficiency of the device according to the invention, the inner walls of the housing and the oscillating members within the housing are made of highly resilient material in a high-Q configuration that is prone to vibration. Such materials include, but are not limited to, sapphire, carbon steel, glass, and quartz. Less resilient materials, such as plastics, stainless steels, or hard rubber may be used for certain applications. Furthermore, the oscillatory members may be designed to have a resonant component, so as to participate in the sonic action on the liquid.

In addition to the device described above, apparatus according to the invention may include external controls and monitoring equipment for controlling the differential pressure, the temperature, and the flow of process liquid through the device. As mentioned above, it may be undesirable for the temperature of the liquid to rise above a certain temperature, as high temperature may negatively influence the taste, odor, or color of the particular foodstuff being sanitized. Thus, cooling may be required to offset heating resulting from exothermic reactions and/or from the heat of friction forces operating on the liquid. On the other hand, heating may be required to offset endothermic reactions. Make-up energy may be introduced to maintain resonance in the event that too much energy is dissipated by the liquid being operated on. For example, liquids such as slurries, colloids, and gels may absorb so much energy from the flow that the desired effect is reduced.

The device according to the invention also achieves homogenization of a non-homogeneous substance, such as milk, simultaneously with the sanitization. Not only does the acoustic energy destroy bacteria, but the acoustic waves also shear large fat globules into much smaller globules, which are much more likely to remain in suspension for an extended period of time.

The device according to the invention may have a primary resonant frequency, or may be operated at many different resonant frequencies or harmonics of the resonant frequency. The primary purpose of the device is to exert high shear forces on the liquid, the thus, the only energy input required is the input that is sufficient to generate the oscillations necessary to obtain the shear forces. In other words, if cavitation is not desired or not required, the high-energy input needed to induce cavitation is then also not required. Flow at non-resonant conditions is not significantly impeded; flow at resonant conditions is severely impeded. The frequency of operation is dependant upon the physical size of the resonant members. Larger size resonant members operate at lower frequencies, and smaller size resonant members at higher frequencies. If cavitation is not required, then the device may be operated at frequencies in the sonic or sub-sonic range. Larger size resonant members, however, increase the amount of fluid processed in a given time. If cavitation is required, then normally, the device must operate at a frequency in excess of 20 kHz (at reasonable amplitudes). In order to attain a frequency that approaches or exceeds 100 kHz, the physical size of the resonant members will necesssarily be small. In order to process production scale quantities of liquid, it may be necessary to operate many devices in parallel to obtain desirable frequencies and flow rates.

### BRIEF DESCRIPTION OF THE DRAWINGS

FIG. 1 is a cross-sectional view of the first embodiment of the acoustic energy device according to the invention.

FIG. 2 is planar view of the single-aperture oscillating disc.

FIG. 3 is a planar view of the spacer disc.

FIG. 4 is a planar view of the multiple-aperture oscillating disc.

FIG. 5A is a side cutaway view of the oscillating disc of FIG. 2, illustrating a first orifice configuration.

FIG. 5B is a cutaway central section side view of the oscillating disc of FIG. 2, illustrating a second orifice configuration.

FIG. 5C is a cutaway side view of the oscillating disc of FIG. 2, illustrating a third orifice configuration.

FIG. 6 is a planar view of the device of FIG. 1.

FIG. 7 is a cross-sectional view of second embodiment of the acoustic energy device according to the invention.

FIG. 8A is a schematic diagram of a pulse generator coupled to the acoustic energy device of FIG. 7.

FIG. 8B is an illustration of a pulse generated by the pulse generator of FIG. 8A.

### DETAILED DESCRIPTION OF THE INVENTION

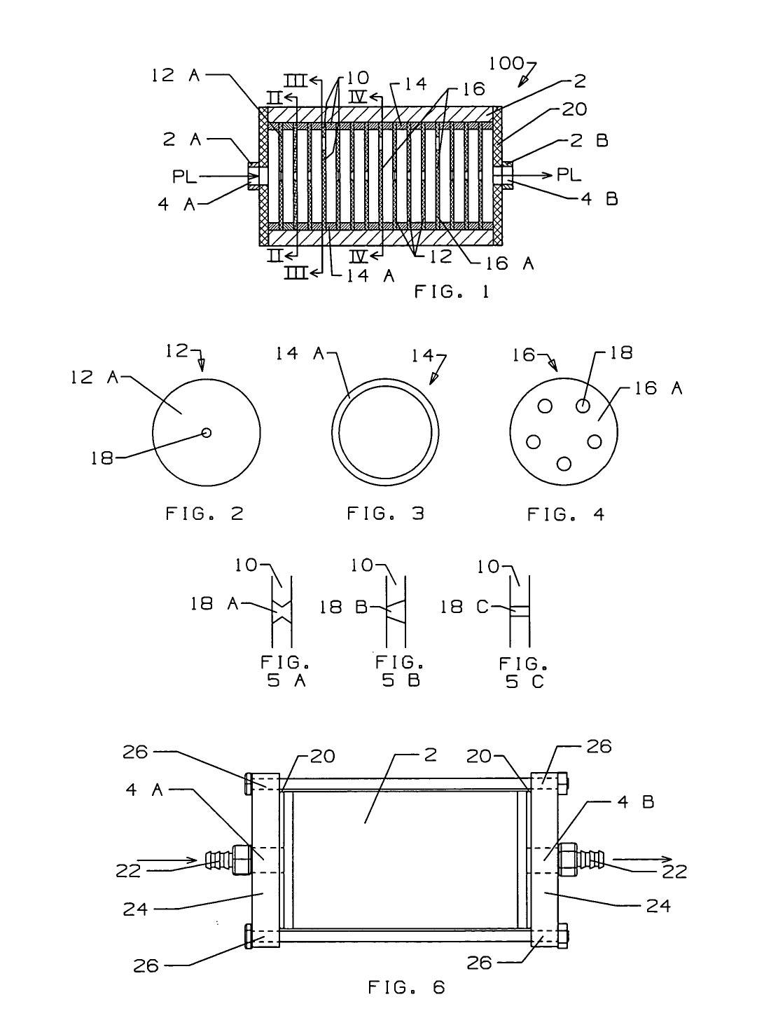

FIG. 1 is a cross-sectional view of a first embodiment of an acoustic energy device 100 for sanitizing a process liquid PL. The acoustic energy device 100 comprises a housing 2 with a plurality of baffles 10 and spacers 14 arranged therein, an inlet 4A at a first housing end 2A, and an outlet 4B at a second housing end 2B. Each baffle 10 has at least one aperture 18. In this first embodiment, the plurality of baffles 10 includes a first plurality 12 of single-aperture baffles 12A and a second plurality 16 of multiple-aperture baffles 16A. Planar views of the baffles 10 and spacers 14 are shown in FIGS. 2-4: FIG. 2 shows the single-aperture baffle 12A; FIG. 3 the spacer 14, and FIG. 4 the multiple-aperture baffle 16A.

As seen in FIG. 1, the baffles 10 are assembled such that one spacer 14 is placed between each one of the baffles 10. The first plurality 12 of single-aperture baffles 12A comprises groups of three single-aperture baffles 12A, each group of three single-aperture baffles 12A being separated from an adjacent group of single-aperture baffles 12A by a multiple-aperture baffle 16A. Depending on the parameters of the particular application, the aperture 18 in the baffles 10 may have a particular shape. FIGS. 5A-5C illustrate some suitable shapes for apertures. FIG. 5A shows a venturi-like aperture 18A, FIG. 5B a nozzle-like aperture 18B, and FIG. 5C a straight-walled aperture 18C. Depending on the desired effects, the number of baffles in the various groups of baffles may vary.

A pressure differential is applied across the acoustic energy device 100, forcing a continuous flow of the process liquid PL from the inlet 4A toward the outlet 4B. The flow of the process liquid PL becomes turbulent as it flows through the aperture 18 in the baffle 12a. The turbulence causes the baffles 10 to oscillate and create acoustic waves. The baffles 10 and the housing 2 are made of highly resilient material which promotes the propagation of acoustic waves from the baffles 10 through the process liquid PL to other baffles 10 and to the walls of the housing 2 and back through the process liquid PL toward the baffles 10.

In the embodiment shown in FIG. 1, the process liquid PL flows into the inlet 4A and is forced to flow through a series of single-aperture baffles 12A. The apertures 18 change the velocity of flow and create turbulence in the flow. This turbulence causes the process liquid PL to move into and out of the space between any two baffles 10, thereby increasing the dwell time of the process liquid PL in the acoustic energy device 100 and increasing the probability of exposure of each molecule of the process liquid PL to shear and friction forces generated by the vibrating baffles 10. The multiple-aperture baffle 1 6A serves to interrupt any linear flow of the process liquid PL, again increasing the probability of exposure to shear and friction forces.

FIG. 6 is a view of the assembled acoustic energy device 100. The housing 2 is a tube with a seal 20, such as an O-ring, assembled at the inlet 2A and outlet 2B. Two end plates or caps 24 are used to seal the housing 2. Each cap 24 has a center hole for receiving a nipple 22 and four through-holes 26 for receiving fastening bolts. The caps 24 are bolted together as shown in FIG. 6, to seal the housing 2. The nipple 22 at each end of the acoustic energy device 100 serves to connect the acoustic energy device 100 to a hose (not shown) that feeds the process liquid PL into and away from the acoustic energy device 100.

Ideally, the amount of flow energy applied to the device is sufficient to generate shear forces that are extreme enough to rupture the cell walls of micro-organisms present in the process liquid PL. The particular application will determine the amount of input flow energy that is required to result in destruction of harmful microbes in the process liquid PL. For example, process liquids PL that contain absorbent materials, such as gels or slurries, may require greater energy input, as such materials absorb large amounts of energy. The amount of energy is controllable in a number of ways that include, but are not limited to, varying the turbulence and the dwell time of the process liquid PL in the acoustic energy device 100 by adapting the rate of flow, the spacing of the baffles 10, or the configuration of single-aperture baffles 12A and multiple-aperture baffles 16A. Under otherwise constant conditions, moving the baffles 10 closer together, for example, will increase the shear forces exerted on the process liquid PL; moving them farther apart will decrease the shear forces.

FIG. 7 is a cross-sectional view of a second embodiment of an acoustic energy device 200 according to the present invention. A housing 40 has a first housing end 40A forming an inlet 44 and a second housing end 40B forming an outlet 46. The housing 40 encloses a pair of piezoelectric members 50 that oscillate in a direction transverse to the direction of flow of the process liquid PL. A dividing wall 42 is provided in the housing 40 and extends between the inlet 44 and the outlet 46, thereby forcing the process liquid PL into close proximity to one or the other member of the pair of piezoelectric members 50. The dividing wall 42 may be made of a resilient material and be used to effectively transfer energy through the process liquid PL from one side of the acoustic energy device 100 to the other.

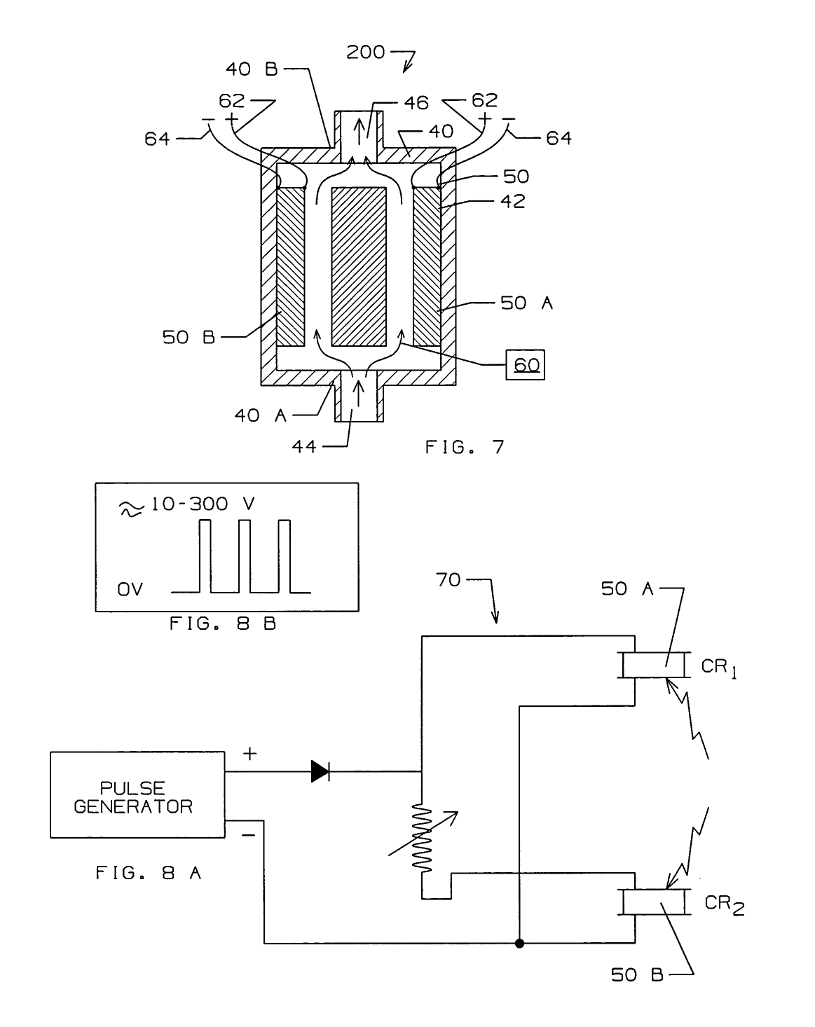

The pair of piezoelectric members 50 comprises a first piezoelectric member 50A and a second piezoelectric member 50B. The one or both of the piezoelectric members 50A, 50B is electrically connected to an oscillating circuit 60 (shown in FIG. 8A) by connecting leads 62, 64. Depending on the particular application, the pair of piezoelectric members 50 is wired to pulse simultaneously storing the energy in capacitors, that is, each member 50A, 50B expands or contracts simultaneously, or are wired to pulse in opposite directions, that is, when member 50A expands, member 50B contracts, fly-wheeling energy between them. The piezoelectrica oscillating circuit 60 is basically a tank circuit and inductors and/or capacitors may be added as needed to tune the circuit.

In another configuration of the acoustic energy device 200, multiple pairs of piezoelectric members 50 are connected in series. This configuration increases the dwell time of the process fluid PL in the device and the efficiency of the acoustic energy device 200 by ensuring 100% exposure of the process fluid PL to the desired forces and applying the desired amount of work to the process fluid PL. This series configuration lends itself to applications in which the process liquid PL is a slurry, colloid, or gel that may dampen the flow-to-acoustical energy transformation to such an extent that resonance, and thus, the work operating on the process liquid PL, are not sustainable. In such applications, make-up energy is introduced into the process to aid in maintaining resonance. As illustrated in FIGS. 8A and 8B, a pulse generator 70 adds energy to the piezo-electric members 50 through a diode D1. This make-up energy sympathetically reinforces the oscillations of the piezo-electric members 50.

As mentioned above, the housing and oscillatory members of each embodiment are preferably constructed in a high-Q configuration from a highly resilient material, such as sapphire, carbon steel, glass, or quartz. Less resilient material, such as plastic materials, stainless steels, or hard rubbers, or a combination of resilient and other materials, are suitable for applications that require lower frequencies and/or where a less efficient transducer is acceptable.

The embodiments of the invention mentioned herein are merely illustrative of the present invention. It should be understood that a person skilled in the art may contemplate many variations in construction of the present invention in view of the following claims without straying from the intended scope and field of the invention herein disclosed.

1. An acoustic energy device for converting flow energy of a process liquid to acoustic energy, said device comprising:
a housing having an inner diameter, a first housing end with an inlet orifice, a second housing end with an outlet orifice, and an expanded flow area extending between said inlet orifice and said outlet orifice; and
oscillatory means assembled within said expanded flow area;
wherein said inlet orifice is narrower in diameter than said inner diameter and a flow of said process liquid through said inlet orifice into said expanded flow area results in turbulent flow; and
wherein said turbulent flow causes said oscillatory means to vibrate.

2. The acoustic device of claim 1, said housing having a longitudinal axis that extends from a center point of said first housing end to a center point of said second housing end, wherein said oscillatory means includes a plurality of baffles, each baffle of said plurality of baffles having a face with a through-hole and an outer perimeter of said face corresponding substantially with said inner diameter of said housing, and wherein said baffle is assembled within said housing such that said face is aligned transverse to said longitudinal axis of said housing.

3. The acoustic device of claim 2, wherein said baffle includes a flow-control baffle, wherein said through-hole of said flow-control baffle is a flow-control aperture with a small diameter.

4. The acoustic device of claim 3, wherein said baffle includes at least two of said flow-control baffle and a spacer, wherein said through-hole of said spacer is a pass-through aperture having a diameter substantially larger than said small diameter of said flow-control aperture, and wherein each said flow-control baffle is separated from another said flow-control baffle by said spacer.

5. The acoustic device of claim 4, wherein said flow-control baffle includes a single-aperture flow-control baffle and a multiple-aperture flow-control baffle, said single-aperture baffle having a single flow-control aperture and said multiple-aperture baffle having multiple flow-control apertures.

6. The acoustic device of claim 1, further comprising a housing seal assembly comprising a seal cap, an 0-ring, and a nipple insert, said assembly fitting over said first end of said housing and said nipple insert providing a flow path into said inlet.

7. The acoustic device of claim 1, wherein said oscillatory means includes an oscillatory circuit and a pair of piezoelectric members electrically connected to said oscillatory circuit, said pair of piezoelectric members including a first piezoelectric member and a second piezoelectric member, wherein said flow of said process liquid through said expanded flow area causes said piezoelectric members to vibrate and produce acoustic waves, and wherein said piezoelectric members are arranged such that said acoustic waves emanate from said piezoelectric members in a direction transverse to said longitudinal axis.

8. The acoustic device of claim 7 further comprising a flow partition disposed between said piezoelectric members and extending in a direction parallel to said longitudinal axis.

9. The acoustic device of claim 7, wherein at least said first piezoelectric member is electrically connected to said oscillatory circuit.

10. The acoustic device of claim 7 further comprising a pulse generator, wherein at least said first piezoelectric member is electrically connected to said pulse generator.

11. The acoustic device of claim 7 further comprising multiple pairs of said piezoelectric members, said pairs arranged within said expanded flow area in series.
